(19) United States
(12) Patent Application Publication
(10) Pub. No.: US 2016/0095275 A1
(43) Pub. Date: Apr. 7, 2016

(54) SEED SOWING IMPLEMENT

(71) Applicant: Gail Patricia Napora, Broadway, VA (US)

(72) Inventor: Gail Patricia Napora, Broadway, VA (US)

(21) Appl. No.: 14/795,069

(22) Filed: Jul. 9, 2015

Related U.S. Application Data
(60) Provisional application No. 62/059,296, filed on Oct. 3, 2014.

(51) Int. Cl. A01C 7/02

(52) U.S. Cl. CPC A01C 7/02

(57) ABSTRACT

A sowing implement comprises a stake, a depth marker, instructions and a seed support. The stake may comprise a lower end and an upper end. The depth marker may be arranged on the stake at a first predetermined distance from the lower end. The instructions may be arranged on the stake. The seed support may be connected to the stake and configured to hold one or more seeds at a second predetermined distance below the depth marker.

### BRIEF DESCRIPTION OF THE DRAWINGS

The disclosure will be readily understood by the following detailed description in conjunction with the accompanying drawings, wherein like reference numerals designate like structural elements.

FIG. 1 is an example perspective view of a sowing implement according to some of the various embodiments.

FIG. 2A is an example front view of an example sowing implement according to some of the various embodiments.

FIG. 2B is an example back view of an example sowing implement according to some of the various embodiments.

FIG. 3 is an example sowing implement according to some of the various embodiments inserted into the ground.

FIG. 4 is an example perspective view of a sowing implement according to some of the various embodiments.

FIG. 5 is an example front view of a sowing implement according to some of the various embodiments.

FIGS. 6A and 6B are example front views of sowing implements according to some of the various embodiments.

FIG. 7 is an example kit according to some of the various embodiments.

FIG. 8 is an example flowchart of sowing one or more seeds with a sowing implement according to some of the various embodiments.

FIG. 9 is an example flowchart of making a sowing implement according to some of the various embodiments.

FIG. 10 is an example perspective view of a sowing implement according to some of the various embodiments.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments of the present invention are directed towards making the sowing of seeds enjoyable and easy. Specifically, this disclosure discusses a seed sowing apparatus as well as how to how to make and employ the seed sowing apparatus. According to various embodiments, the sowing implement may comprise a stake having instructions located on the stake. In some embodiments, the sowing implement may comprise a depth marker indicating a depth at which a lower end of the sowing implement may be inserted into the ground when employing the sowing implement. In some embodiments, the instructions may inform a user how to employ the sowing implement, including informing the user about the appropriate depth to insert the lower end of the sowing implement into the ground.

Planting and growing plants may be a rewarding experience. It is a good way to enjoy the outdoors. It can also be a fun bonding activity for individuals (e.g., children, sports teams, church groups, etc.). Also, plant growth supports an ecosystem and organisms living in the ecosystem. For example, various insects are dependent on adequate plant growth for survival. Plants provide insects with food, reproductions sites, resting spots, and more.

In the absence of adequate plant growth, an ecosystem and the organisms living therein may suffer. For example, the number of Monarch butterflies has decreased recently due to a decline in milkweed plants along their migration routes. Increasing the number of milkweed plants may aid in reviving the Monarch population. Similar affects may result from an increase in the numbers of a different plant for a different insect.

Embodiments of the sowing implements discussed herein, and associated ways of employing and making them, may educate individuals that may be unfamiliar with horticulture and introduce them to its benefits, thereby encouraging participation in horticulture activities (e.g., the planting and growing of plants). By encouraging and facilitating planting and growing of plants, not only may the quality of the ecosystem be improved, but the fun and enjoyment of planting and growing plants may be exposed. Accordingly, embodiments of the sowing implements and ways of employing them discussed may herein help the environment and encourage active participation in preserving and improving the environment.

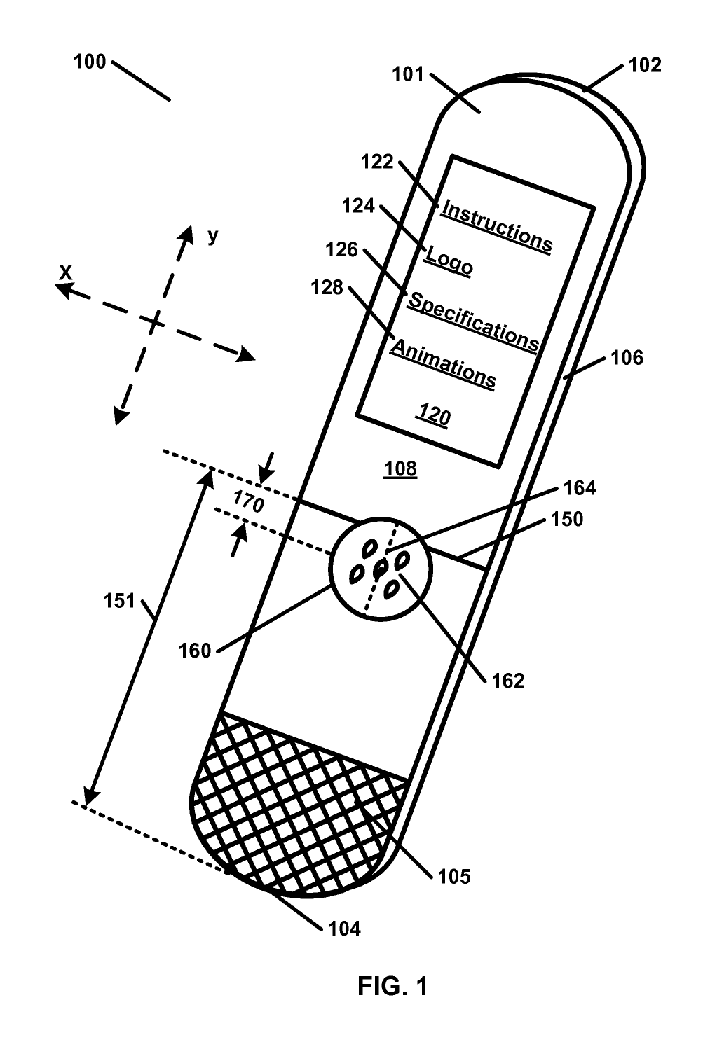

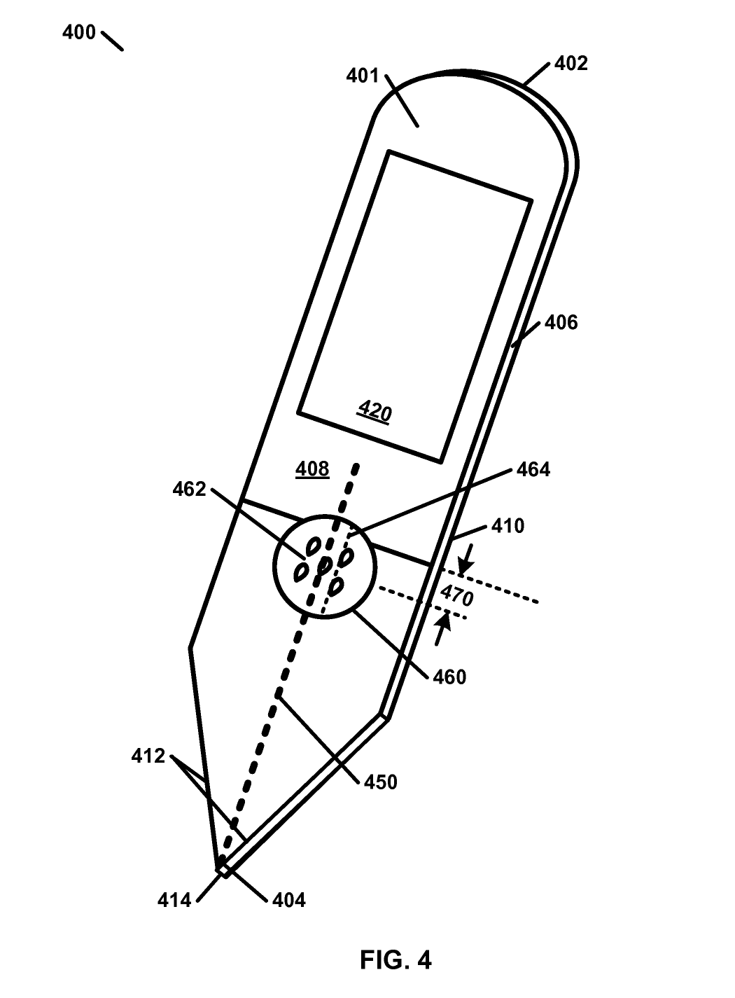

FIG. 1 illustrates a sowing implement 100 according to an embodiment. Sowing implement 100 may comprise a stake 101 having a lower end 104 and an upper end 102. Lower end 104 may comprise a lower region 105 configured to facilitate insertion of stake 101 into the ground. For example, lower region 105 may be a rounded region (as shown in FIG. 1) or a pointed region (see e.g., FIG. 4) configured to facilitate insertion of stake 101 into the ground. According to some the various embodiments, stake 101 may comprise instructions 122 arranged on stake 101. Instructions 122 may provide a user with information related various aspects of sowing implement 100. Stake 101 may also comprise a depth marker 150 arranged on stake 101. Depth marker 150 may be arranged on stake 101 between lower end 104 and upper end 102 at a predetermined distance 151 from lower end 104. Sowing implement 100 may also comprise a seed support 160 connected to stake 101 and configured to hold one or more seeds 162 relative to stake 101. According to some of the various embodiments, seed support 160 may fix one or more seeds 162 relative to stake 101.

Stake 101 may comprise various structures capable of supporting seeds and capable of being inserted into the ground without significantly damaging stake 101 or seeds 162. According to some of the various embodiments, a side wall 106 of stake 101, or a portion of side wall 106, may be configured to be sufficiently thick to prevent stake 101 from significant deformation and/or fracturing when stake 101 is inserted into the ground. Stake 101 may be composed of one or more materials. In some embodiments, stake 101 may be a single piece integrally formed employing, for example, but not limited to, injection molding, machining, lathe cutting, a combination thereof, and/or the like. In some embodiments, stake 101 may be composed of multiple pieces attached using, for example, but not limited to, an adhesive, a friction fit, welding, a combination thereof, and/or the like. For example, in some of the various embodiments, an upper portion of stake 101 may be composed of a first material having specific dimensions (i.e., height, width, length) and shape and a lower portion of stake 101 may be composed of a second material having specific dimensions (i.e., height, width, length) and shape. The material of the upper portion and the lower portion may be substantially the same or different. Also, the dimensions and shape of the upper portion and the lower portion may be substantially the same or different.

According to some of the various embodiments, stake 101 may have various cross-sectional and 3-dimensional shapes. According to some of the various embodiments, stake 101 may have a cross-sectional shape in a direction parallel to an X-axis shown in FIG. 1 including, but not limited to, a circular shape, an ovoid shape, a triangular shape, a rectangular shape, a square shape, a combination thereof, and/or the like. According to some of the various embodiments, stake 101 may have a cross-sectional shape in a direction parallel to the Y-axis shown in FIG. 1 including, but not limited to, a circular shape, an ovoid shape, a triangular shape, a rectangular shape, a square shape, a combination thereof, and/or the like.

According to some of the various embodiments, the cross-sectional shape of stake 101 in the X-direction may be substantially constant when moving up and down the Y-axis. According to some of the various embodiments, the cross-sectional shape of stake 101 in the X-direction may change when moving up and down the Y-axis. As a non-limiting example, the surface area of the cross-sectional shape of stake 101 in the X-direction may increase when moving from lower end 104 to upper end 102. According to some of the various embodiments, the cross-sectional shape of stake 101 in the Y-direction may be substantially constant when moving along the X-axis. According to some of the various embodiments, the cross-sectional shape of stake 101 in the Y-direction may change when moving along the X-axis.

According to some of the various embodiments, stake 101 may have a 3-dimensional shape including, but not limited to, a conical shape, a cylindrical shape, a triangular shape, a rectangular shape, a combination thereof, and the like. According to some of the various embodiments, the 3-dimensional shape of stake 101 may remain substantially the same along the length of stake 101 (i.e., along the Y-axis). According to some of the various embodiments, the 3-dimensional shape of stake 101 may change along the length of stake 101 (i.e., along the Y-axis).

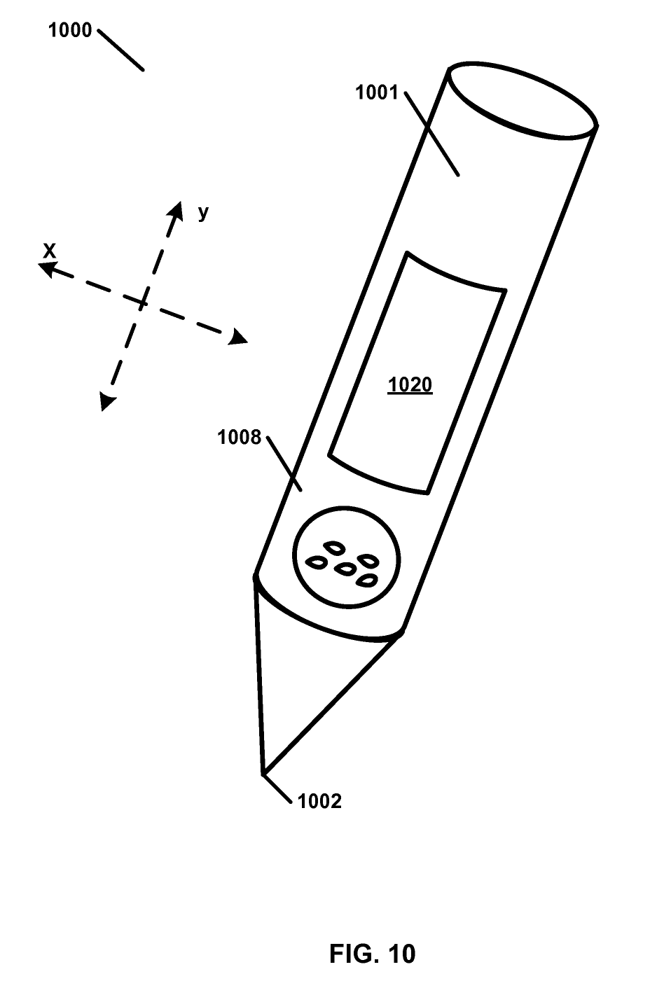

FIG. 10 shows a sowing implement 1000 having one of a multitude of alternative shapes. As illustrated in FIG. 10, a sowing implement 1000 comprises a stake 1001 having a cylindrical shape according to some of the various embodiments. As shown in FIG. 10, stake 1001 may comprise a cylindrical shape with a cross-sectional area of stake 1001 in the X-direction that decreases when moving down the Y-axis towards a lower end 1002 of stake 1001. In some embodiments, stake 101, or a portion thereof, may have a 3-dimensional shape configured to float.

According to some of the various embodiments, stake 101 may be made, in whole or in part, of a biodegradable material. In some embodiments, stake 101 may be made, in whole or in part, of the following materials: a wooden material, a polymeric material, a metallic material, a combination thereof, and/or the like. Suitable wooden materials, include, but are not limited to: pine wood, balsa wood, oak wood, a combination thereof, and/or the like. Suitable polymeric materials, include but are not limited to: polyethylene, polyurethane, cellulose (e.g., cellulose esters like cellulose acetate and nitrocellulose and their derivatives), polyvinyl alcohol, polyanhydrides, a combination thereof, and/or the like. Suitable metallic materials include, but are not limited to: aluminum, iron, steel, tin, a combination thereof, and/or the like. In some embodiments, stake 101 may be made, in whole or in part, of a buoyant material.

Instructions 122 may be arranged on one or more locations on stake 101. In some embodiments, all, or a portion of, instructions 122 may be arranged on a front surface 108 of stake 101. In some embodiments, all, or a portion of, instructions 122 may be arranged on a back surface (not shown) of stake 101. In embodiments comprising a continuous sidewall (e.g., side wall 1008 of cylindrically shaped stake 1001 in FIG. 10), instructions (e.g., instructions 1020) may be arranged, in whole or in part, on sidewall 1008.

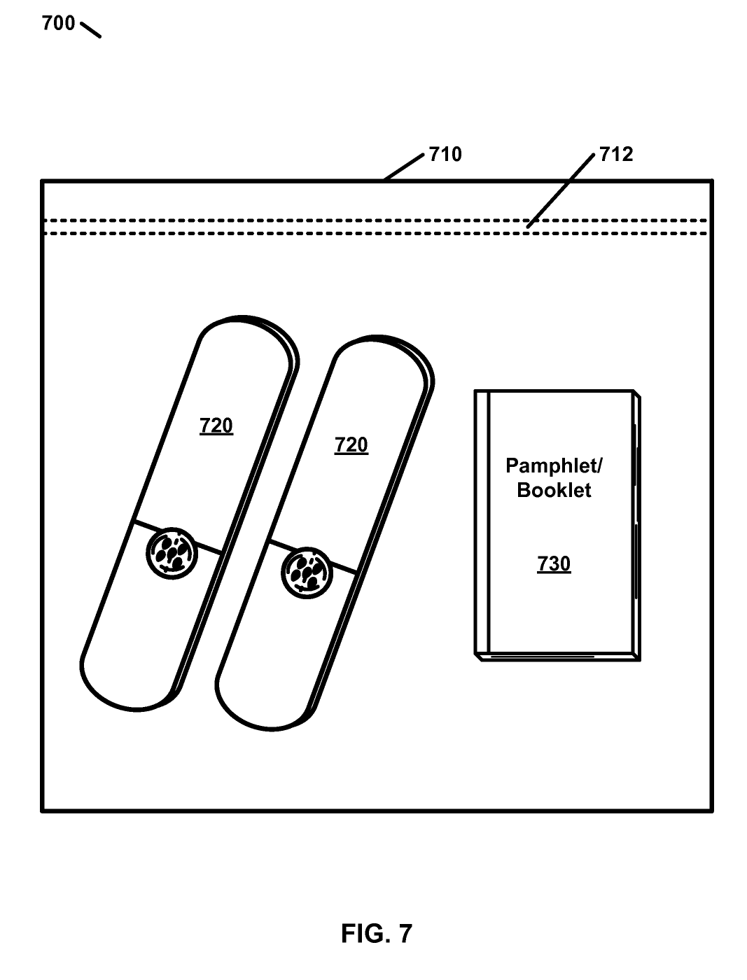

In some embodiments, all, or a portion of, instructions 122, may not be arranged on stake 101. For example, all, or a portion of, instructions 122 may be provided on an instruction brochure or pamphlet (e.g., pamphlet 730 discussed below in regards to FIG. 7). According to various embodiments, all or a portion of instructions 122 may be printed directly on stake 101. In some embodiments, all or a portion of instructions 122 may be printed on a label 120 affixed to stake 101. In some embodiments, label 120 may be affixed to stake 101 employing an adhesive. In some embodiments, the adhesive may be biodegradable. In some embodiments, instructions 122 may be located above depth marker 150.

Instructions 122 may comprise one or more of the following: instructions regarding how to use sowing implement 101, instructions regarding which direction front surface 108 of stake 101 should face when inserted into the ground, instructions regarding how to water seeds 162, instructions regarding where to locate sowing implement 101 (e.g., near a water source or under a tree), instructions regarding the depth to which the stake 101 is to be inserted into the ground, combinations thereof, and/or the like.

According to some of the various embodiments, instructions 122 may include a logo 124. Logo 124 may comprise a company logo, a brand logo, a product logo, a combination thereof, and/or the like. In some embodiments, instructions 122 may comprise a specification 126. Specification 126 may comprise information regarding, for example, one or more of the following: the type of the one or more seeds 162 supported by seed support 160, attributes of the one or more seeds 162, attributes of a plant that the one or more seeds 162 will mature into, the name of a plant that the one or more seeds 162 will mature into, optimal growing conditions for the one or more seeds 162, a growing time for the one or more seeds 162, combinations thereof, and/or the like. In some embodiments, instructions 122 may comprise an animation 128. Animation 128 may comprise a picture or set of pictures. For example, animation 128 may comprise a picture of a plant, a picture of an insect (e.g., a Monarch butterfly), a set of pictures illustrating how to use sowing implement 100, a combination thereof, and/or the like.

Seed support 160 may be employed to support a multitude of seeds 162. And seed support 160 may be employed to support numerous types of seeds 162. In some embodiments, sowing implement may include a plurality of seed supports 160 supporting one or more types of seeds 162. In some embodiments, seeds 162 may be plant seeds. Such plant seeds may be, but are not limited to: milkweed seeds, sunflower seeds, impatiens seeds, daisy seeds, coneflower seeds, black-eyed Susan seeds, dandelion seeds, combinations thereof, and/or the like. In some embodiments, seeds 162 may be underground organism “seeds” (i.e. eggs or immature organisms), such as but not limited to: aquatic organisms, lotus flower seeds, sponges, yeasts, fungi, moss and fern spores, dormant cyst protozoans, combinations thereof, and/or the like. In some embodiments, seed support 160 may be connected to front surface 108 of stake 101. In some embodiments, seed support 160 may be connected to back surface (not shown) of stake 101. In some embodiments seed support 160 may be connected to a side wall 106 of a stake (e.g., side wall 1008 of stake 1001).

Seed support 160 may be composed of one or more materials. In some embodiments, seed support 160 may be made, in whole or in part, of a biodegradable material. In some embodiments, seed support 160 may be made, in whole or in part, of a dissolvable material (e.g., a material comprising sugar or starch). In some embodiments, seed support 160 may be made, in whole or in part, of a porous material. In some embodiments, seed support 160 may be made, in whole or in part, of a polymeric material. Suitable polymeric materials include, but are not limited to: polyethylene, polyurethane, cellulose (e.g., cellulose esters like cellulose acetate and nitrocellulose and their derivatives), polyvinyl alcohol, polyanhydrides, combinations thereof, and/or the like. In some embodiments, seed support 160 may be made, in whole or in part, of a paper-like material. In some embodiments, seed support 160 may be made, in whole or in part, of a combination of materials. The combinations may be laminated, mixed, cast, molded, combinations thereof, and/or the like.

According to some of the various embodiments, seed support 160 may be water permeable so that seeds 162 may receive water when held by seed support 160. Seed support 160 may serve to hold (and/or fix) seeds 162 relative to stake 101, but may also be fragile enough to allow a plant growing from one or more seeds 162 to break though seed support 160. In some embodiments, seed support 160 may comprise a perforated portion 164 configured to break when a plant begins to emerge from one or more seeds 162. In some embodiments, seed support 160 and/or stake 101 may comprise a cavity configured to hold and protect one or more seeds 162.

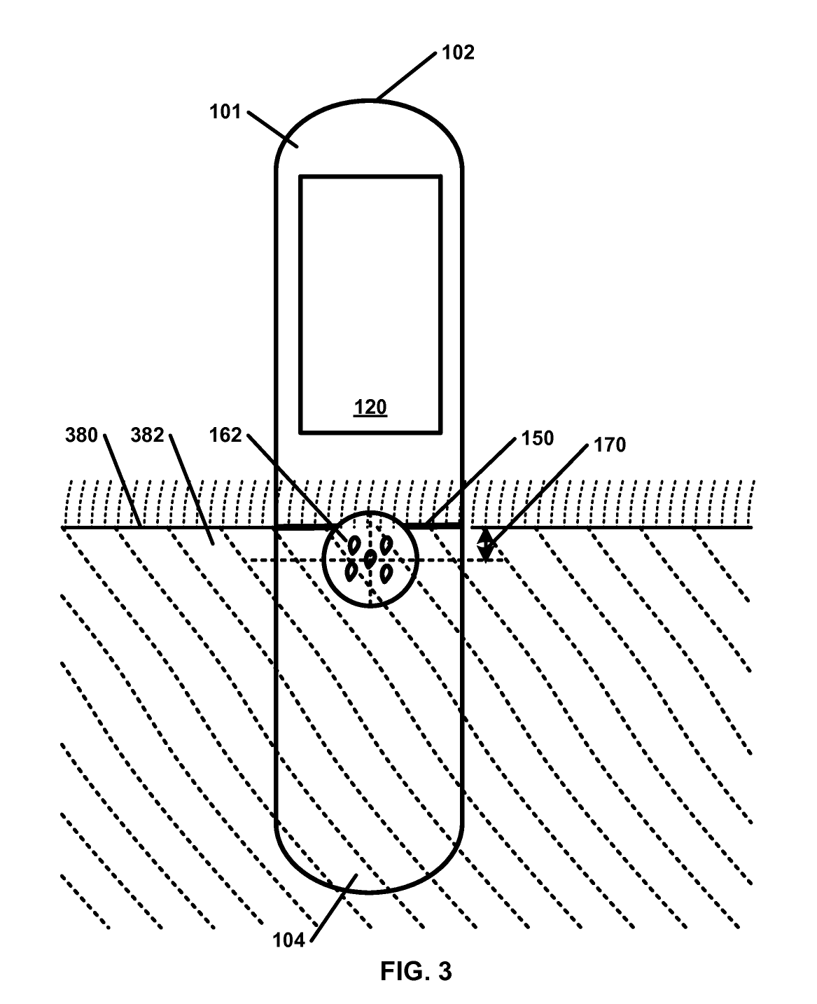

Seed support 160 may be employed to fix one or more seeds 162 relative to depth marker 150. In some embodiments, seed support 160 may be employed to fix one or more seeds at a predetermined distance 170 below depth maker 150 (i.e., between depth marker 150 and lower end 104 of stake 101) (see FIG. 3). In some embodiments, predetermined distance 170 may be ⅛ of an inch or more. In some embodiments, predetermined distance 170 may be based on the type of the one or more seeds 162 held by seed support 160. Predetermined distance 170 may be a minimum distance that one or more seeds may be planted into the ground (i.e., below ground level) to ensure growth of seeds 162. As shown in FIG. 3, predetermined distance 170 may be employed in connection with depth marker 150 to position seeds 162 at a minimum distance below a surface of the ground. If seeds 162 are not planted deep enough into the ground, they may not grow properly due to, for example, over exposure to sunlight or due to receiving inadequate nutrients.

Depth marker 150 may comprise a suitable indicator for indicating a depth at which a user may insert stake 101 into the ground. Depth marker 150 may comprise one or more indicators, such as, but not limited, a color indicator, an arrow indicator, a line indicator, and/or the like. In some embodiments, depth marker 150 may be printed on stake 101. In some embodiments, depth marker 150 may be included on a label (e.g., label 120) affixed to stake 101. In some embodiments, stake 101 may define at least a portion of depth marker 150. For example, stake 101 may comprise a change in size and/or shape (e.g., a depression or projection) that marks the location of depth marker 150. In some embodiments, depth marker 150 may be located on front surface 108 of stake 101 (as shown in FIG. 1). In some embodiments, depth marker 150 may be located on back surface (not shown) of stake 101. In some embodiments depth marker 150 may be located on a side wall 106 of a stake.

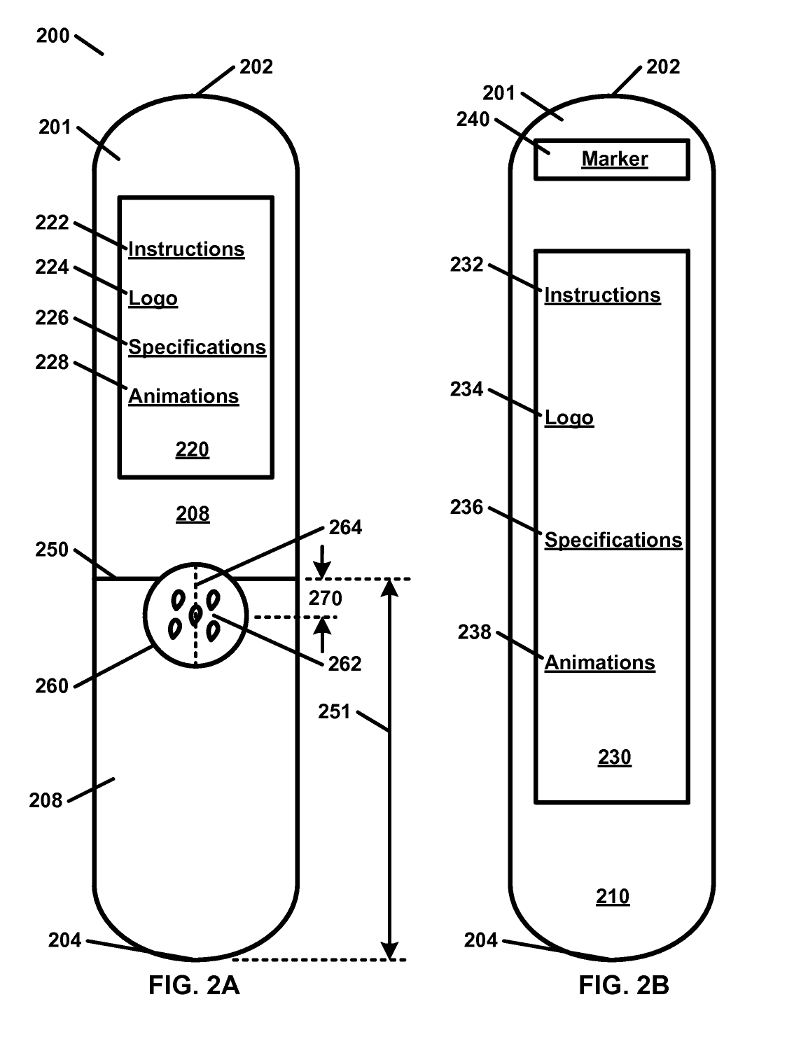

FIGS. 2A and 2B show a sowing implement 200 according to an embodiment. Sowing implement 200 may comprise a stake 201 having a lower end 204, an upper end 202, a front surface 208, and a back surface 210. FIG. 2A shows front surface 208 comprising instructions 222 arranged on front surface. Instructions 222 may be the same as or similar to instructions 122. Instructions 222 may comprise a logo 224, which may be the same as or similar to logo 124. Instructions 222 may comprise a specification 226, which may be the same as or similar to specification 126. And instructions may comprise an animation 228, which may be the same as or similar to animation 128. According to various embodiments, instructions 222 may be printed on front surface 208. According to various embodiments, instructions 222 may be printed on a front label 220 that may be affixed to front surface 208.

Front surface 208 may also comprise a depth marker 250 arranged on front surface 208. Depth marker arranged 250 may be arranged on front surface 208 between lower end 204 and upper end 202 at a predetermined distance from lower end 204. As shown in FIG. 2A, depth marker 250 may be a substantially horizontal line across the width of the marker 250 at a distance 251 from lower end 204 of sowing implement 200. The line of depth marker 250 may have color and may have one or more of numerous thicknesses. According to various embodiments, the line of depth marker 150 may be a solid line. In some embodiments, the line of depth maker 150 may be a dashed line.

Sowing implement 200 may comprise a seed support 260 connected to stake 201 and configured to hold one or more seeds 262 relative to stake 201. Seed support 260 may be the same as or similar to seed support 160. In some embodiments, seed support 260 may comprise a perforated portion 264. In some embodiments, seed support 260 may be configured to hold one or more seeds 262 at a predetermined distance 270 below depth marker 250 (i.e., a predetermined distance between depth marker 250 and lower end 204). In some embodiments, predetermined distance 270 may be ⅛ of an inch or more. In some embodiments, predetermined distance 270 may be based on the type of the one or more seeds 262 held by seed support 260.

FIG. 2B shows back surface 210 of sowing implement 200. Back surface 210 may comprise instructions 232 arranged on back surface 210. Instructions 232 may be the same as or similar to instructions 122. Instructions 232 may comprise a logo 234, which may be the same as or similar to logo 124. Instructions 232 may comprise a specification 236, which may be the same as or similar to specification 126. And instructions 232 may comprise an animation 238, which may be the same as or similar to animation 128. In some embodiments, instructions 232 may be printed on back surface 210. In some embodiments, instructions 232 may be printed on a back label 230 that may be, for example, affixed to back surface 210. In some embodiments, back surface 210 may comprise a maker 240. Marker 240 may serve as a location indicator for sowing implement 200. Marker 240 may be configured to be visible when sowing implement 200 is inserted into the ground, which may protect sowing implement 200, and seeds 262, from accidental damage (e.g., protect sowing implement 200 from being stepped on). In some embodiments, marker 240 may be alternatively or additionally located on front surface 208.

FIG. 3 shows sowing implement 100 inserted into the ground 382. Sowing implement 100 may comprise a stake 101 having a label 120. As shown in FIG. 3, depth marker 150 may align with the surface 380 of ground 382. Aligning depth marker 150 with surface 380 may ensure that seeds 162 are located a distance approximately equal to predetermined distance 170 below surface 380. As discussed above, this may facilitate growth of seeds 162. Instructions (e.g., instructions 122) may instruct a user of sowing implement 100 to insert it into the ground such that depth marker 150 aligns with (i.e., is flush with) surface 380 of ground 382. As shown in FIG. 3, upper end 102 of stake 101 and instructions 120 may remain above surface 380 when sowing implement 100 is inserted to ground 382.

FIG. 4 shows a sowing implement 400 according to various embodiments. Sowing implement 400 may comprise a stake 401 having a front surface 408. Front surface 408 of sowing implement 400 may comprise a label 420 arranged on front surface 408. Label 420 may comprise instructions (e.g., instructions 122). Front surface 408 may comprise a depth marker 450 arranged on front surface 408. Depth marker arranged 450 may be arranged on front surface 408 between a lower end 404 and an upper end 402 of stake 401.

As shown in FIG. 4, depth marker 450 may be, for example, a substantially vertical line parallel to a side wall 406 of stake 401. The line of depth marker 450 may have color and may have one or more of numerous thicknesses. In some embodiments, the line of depth marker 450 may be a solid line. In some embodiments, the line of depth maker 450 may be a dashed line (as shown in FIG. 4). In alternative embodiments, the line of depth maker 450 may comprise other characteristics including, for example, various thicknesses, colors, shapes, combinations thereof, and/or the like. A back surface 410 of stake 401 may comprise some or all of the features of back surface 210 discussed above in regards to FIG. 2B.

Sowing implement 400 may also comprise a seed support 460 connected to stake 401 and configured to hold one or more seeds 462 relative to stake 101. Seed support 460 may be the same as or similar to seed support 160. In some embodiments, seed support 460 may comprise a perforated portion 464. In some embodiments, seed support 460 may be configured to hold one or more seeds 462 at a predetermined distance 470 below depth marker 450 (i.e., a predetermined distance between depth marker 450 and lower end 404). In some embodiments, predetermined distance 470 may be 1/8 of an inch or more. In some embodiments, predetermined distance 470 may be based on the type of the one or more seeds 462 held by seed support 460.

As shown in FIG. 4, lower end 404 of stake 401 may comprise a pointed region defined by slanted walls 412 and a pointed end 414. Slanted walls 412 and pointed end 414 may facilitate insertion of lower end 404 into the ground (e.g., ground 380). In particular, slanted walls 412 and pointed end 414 may facilitate the insertion of lower end 404 into a relatively hard ground, such as ground composed of a clay soil.

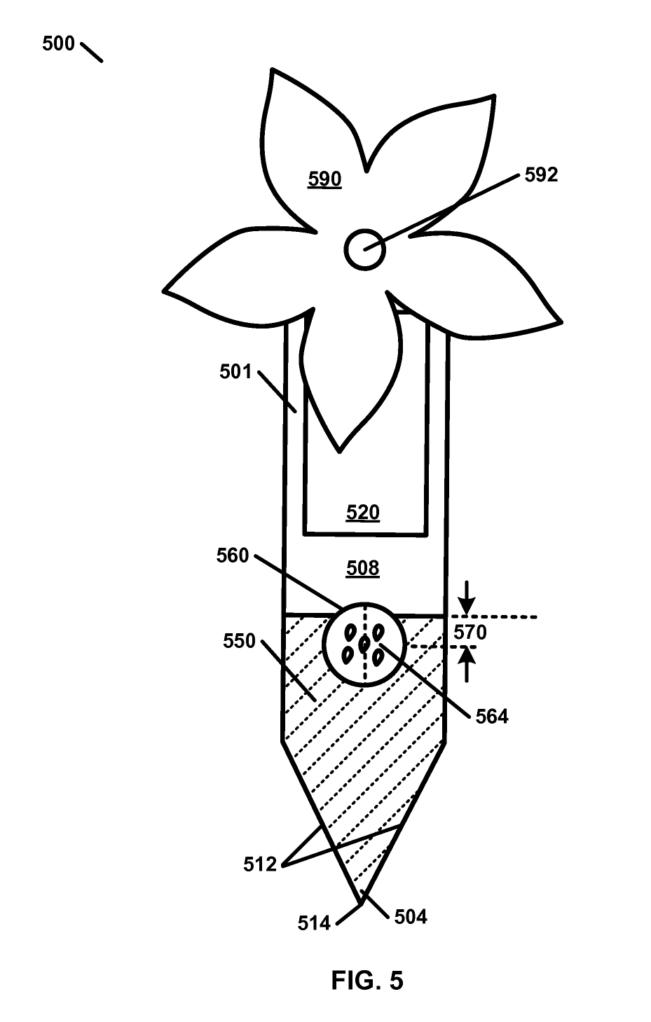

FIG. 5 shows a sowing implement 500 according to an embodiment. Sowing implement 500 may comprise a stake 501 having a front surface 508. Front surface 508 of sowing implement 500 may comprise a label 520 arranged on front surface 508. Label 520 may comprise instructions (e.g., instructions 122). Front surface 508 may comprise a depth marker 550 arranged on front surface 508. Depth marker arranged 550 may be arranged on front surface 508 between a lower end 504 and an upper end of stake 501. As shown in FIG. 5, depth marker 550 may comprise a colored or shaded region located at lower end 504 of stake 510. In some embodiments, colored region may extend completely across front surface 508 of stake 501 (i.e., extend between opposing sides walls of stake 501). A back surface (not shown) of stake 501 may comprise some or all of the features of back surface 210 discussed above in regards to FIG. 2B.

Sowing implement 500 may comprise a seed support 560 connected to stake 501 and configured to hold one or more seeds 562 relative to stake 501. Seed support 560 may be the same as or similar to seed support 160. In some embodiments, seed support 560 may comprise a perforated portion 564. In some embodiments, seed support 560 may be configured to hold one or more seeds 562 at a predetermined distance 570 below the top of depth marker 550 (i.e., a predetermined distance between the top of depth marker 550 and lower end 504). In some embodiments, predetermined distance 570 may be ⅛ of an inch or more. In some embodiments, predetermined distance 570 may be based on the type of the one or more seeds 562 held by seed support 560.

As shown in FIG. 5, sowing implement may comprise a figurine (e.g. 590). In some embodiments, figurine 590 may be located at, for example, an upper end of stake 501. Figurine 590 may be connected to stake 501 via a fixture 592. Fixture 592 may comprise a mechanical fixture, including, but not limited to: a rivet, a screw, an adhesive, a combination thereof, and/or the like. In some embodiments, figurine 590 may be static. In some embodiments, figurine 590 may be moveable. For example, as shown in FIG. 5, figurine 590 may be a pinwheel having a plurality of pedals. In such embodiments, fixture 592 may comprise a rotatable bearing configured to allow pinwheel 590 to rotate when the wind blows.

Figurine 590 may be configured to increase the aesthetic appeal of stake 501 and may also serve as a marker to protect stake 501, and seeds 564, from damage. While figurine 590 is shown as being associated with sowing implement 500, any of the sowing implements discussed herein may comprise a figurine. Also, while FIG. 5 shows a figurine 590 that is a pinwheel, FIG. 590 may have other various designs, including, but not limited to: a flower-like design, an insect-like design (e.g., a lady bug), an animal, a barn, a combination thereof, and/or the like.

Similar to sowing implement 500, lower end 504 of sowing implement 500 may comprise a pointed region defined by slanted walls 512 and a pointed end 514. Slanted walls 512 and pointed end 514 may facilitate insertion of lower end 504 into the ground (e.g., ground 380).

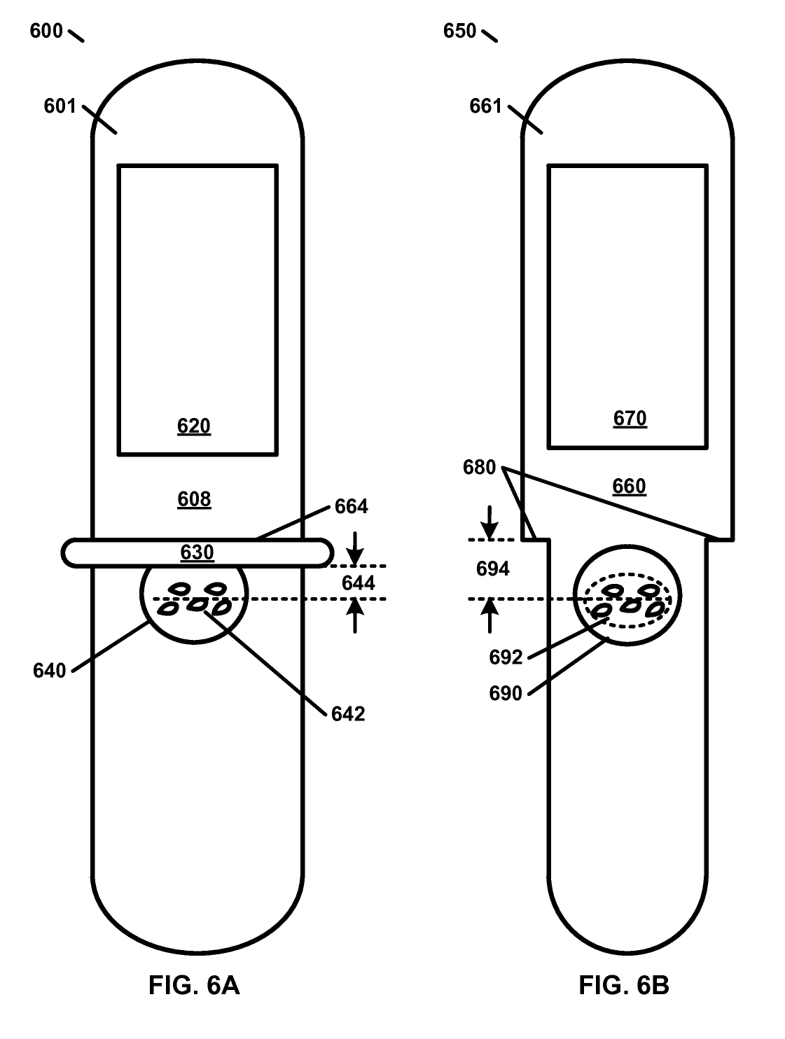

FIGS. 6A and 6B show sowing implements 600 and 650, respectively, having depth makers defined by a change in the size and shape (i.e., dimensions) of a stake according to some embodiments. As shown in FIG. 6A, sowing implement 600 may comprise a stake 601 with a front surface 608 having a label 620 located on front surface 608. Label 620 may be the same as or similar to label 120. Sowing implement 600 may comprise a seed support 640 for holding one or more seeds 642 at a predetermined distance 644 below a depth marker 630. Seed support 640 and predetermined distance 644 may be the same as or similar to seed support 160 and predetermined distance 170, respectively. As shown in FIG. 6A, depth marker 630 may comprise a projection extending from sowing implement 600. In some embodiments, depth maker 630 may comprise more than one projection. In some embodiments, projection may be a circumferential projection extending around a portion of sowing implement 600. In some embodiments, the projection(s) may be integrally formed with sowing implement 600. In some embodiments, the projection(s) may be separate pieces connected to sowing implement 600 using, for example, an adhesive.

As shown in FIG. 6B, sowing implement 650 may comprise a stake 661 having a front surface 660 and a label 670 located on front surface 660. Label 670 may be the same as or similar to label 120. Sowing implement 650 may comprise a seed support 690 for holding one or more seeds 692 at a predetermined distance 694 below a depth marker 680. Seed support 690 and predetermined distance 694 may be the same as or similar to seed support 160 and predetermined distance 170, respectively. As shown in FIG. 6B, depth marker 680 may comprise a depression formed in sowing implement 650. In some embodiments, the depression may extend from a predetermined location on sowing implement 650 to the lower end of sowing implement 660. The depression may serve to facilitate the insertion of sowing implement into the ground by reducing the width of sowing implement 650 at its lower end.

FIG. 7 shows a kit 700 for sowing seeds according to an embodiment. Kit 700 may comprise a package 710 containing instructions 730 and one or more sowing implements 720. The one or more sowing implements 720 may be any of the sowing implements discussed herein (i.e., sowing implements 200, 400, 500, 600, 650). Instructions 730 may be in the form of a booklet, brochure, or pamphlet. And instructions 730 may comprise any or all of the information discussed above for instructions 122.

Package 710 may comprise a packaging container comprising, but not limited to, a bag, a plastic container, a tin, a box, a combination thereof, and/or the like. In some embodiments, package may be sealed (e.g., via a seal 712). In some embodiments, the one or more the sowing implements 720 contained in package 710 may be substantially similar. In some embodiments, the one or more sowing implements 720 contained in package 710 may be different.

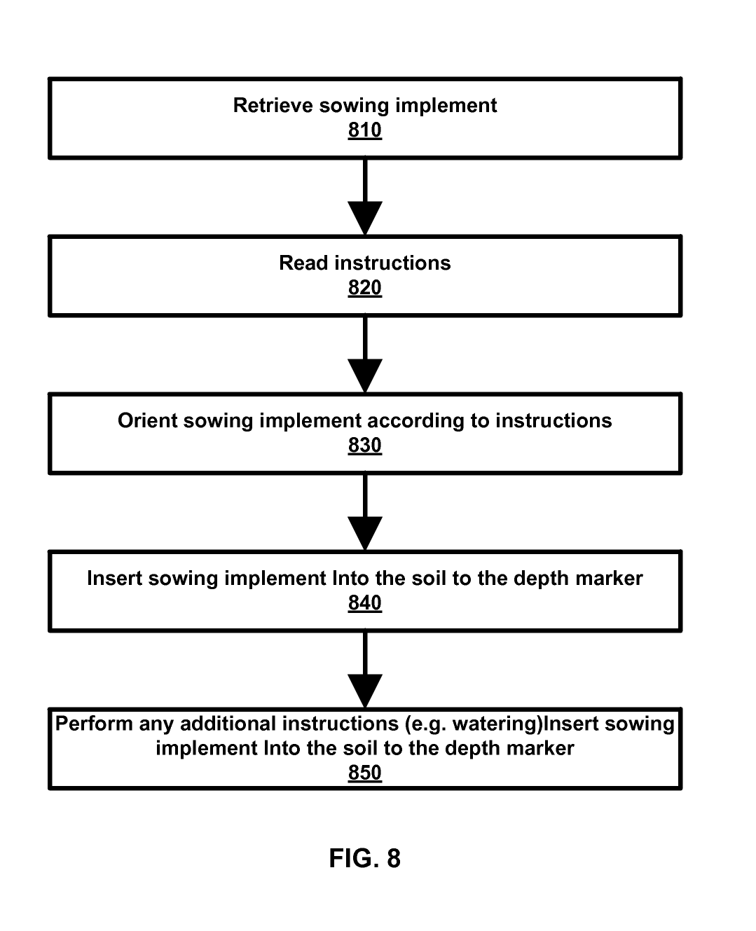

FIG. 8 shows a flowchart illustrating a process 800 of sowing one or more seeds with a sowing implement (e.g., sowing implement 100) according to an embodiment. Process 800 may be employed to plant one or more seeds held by a sowing implement. At 810, a sowing implement (e.g., sowing implement 100) may be retrieved. The sowing implement may be retrieved by, for example, buying a sowing implement available in a store or online. In some embodiments, retrieving a sowing implement may comprise making the sowing implement. The sowing implement may be made by employing, for example, the process discussed below.

At 820, instructions (e.g., instructions 122) may be read by a user. In 830, a front surface (e.g., front surface 108) of the stake may be oriented in a specific direction. The orientation of the front surface may be performed before inserting the sowing implement into the ground. Orienting the front surface of a sowing implement in a specific direction (e.g., pointing west) may help ensure that a plant emerging from one or more seeds supported on the sowing implement receives proper sunlight when it emerges from the ground.

At 840, a lower end of a sowing implement (e.g., lower end 104 of sowing implement 100) may be inserted into the ground so that a depth marker (e.g., depth maker 150) located on the sowing implement is substantially level with a surface of the ground. This may ensure that one or more seeds supported on the sowing implement are located below the ground. As illustrated in FIG. 3, aligning the depth marker so that it is level with the surface of the ground may ensure that the seeds are located at a predetermined distance (e.g., distance 170) below the surface of the ground. In some embodiments, insertion of the lower end of the sowing implement into the ground in 840 may performed in accordance with instructions (e.g., the instructions read at 820).

At 850, additional actions associated with planting the seeds supported by the sowing implement may be performed. Additional actions may comprise, but are not limited to: watering the one or more seeds, fertilizing the one or more seeds, a combination thereof, and/or the like. Once any additional actions are performed at 850, the seeds supported on the sowing implement may be allowed grow and mature into healthy adult plants.

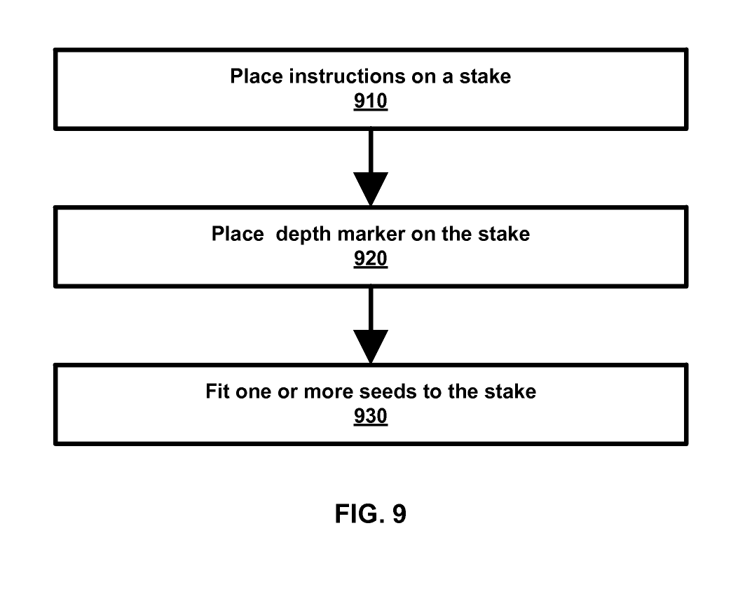

FIG. 9 shows a flowchart 900 illustrating one of various embodiments for making a sowing implement. At 910, instructions (e.g., instructions 122) may be placed on a stake (e.g., stake 101). The placing of instructions may comprise printing the instructions on a surface of the stake (i.e., front surface 108 or back surface 110). In some embodiments, the placing of instructions may comprise affixing a label (e.g., label 120) on a surface of a stake. At 920, a depth marker (e.g., depth marker 150) may be placed on the stake at a first predetermined distance from a lower end (e.g., lower end 104) of the stake. In some embodiments, the depth marker may be printed on stake. In some embodiments, the depth marker may be included on a label affixed to the stake. In some embodiments, the depth marker may be a portion of the stake having a different size and/or shape (i.e., dimensions) from the rest of the stake. At 930, one or more seeds may be fixed to the stake at a second predetermined distance (e.g., distance 170) below the depth marker. In some embodiments, a seed support (e.g., seed support 160) may be used to fix the one or more seeds to the stake.

The foregoing descriptions of the specific embodiments described herein are presented for purposes of illustration and description. These exemplary embodiments are not intended to be exhaustive or to limit the embodiments to the precise forms disclosed. All specific details described are not required in order to practice the described embodiments.

It will be apparent to one of ordinary skill in the art that many modifications and variations are possible in view of the above teachings, and that by applying knowledge within the skill of the art, one may readily modify and/or adapt for various applications such specific embodiments, without undue experimentation, without departing from the general concept of the present inventions. Such adaptations and modifications are intended to be within the meaning and range of equivalents of the disclosed embodiments, based on the teaching and guidance presented herein.

The Detailed Description section is intended to be used to interpret the claims. The Summary and Abstract sections may set forth one or more but not all exemplary embodiments of the present inventions as contemplated by the inventor(s), and thus, are not intended to limit the present inventions and the appended claims.

The present inventions have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the sowing of seeds. However, one skilled in the art will recognize that embodiments of the inventions could be employed in the field of underground organism culturing, such as but not limited to, culturing underground insects. Moreover, embodiments of the invention could be employed in the field of aquatic organism culturing, such as but not limited to: algae, aquatic vertebrates, aquatic invertebrates, combinations thereof, and/or the like.

It should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

The purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

It is the applicant's intent that only claims that include the express language “means for” or “step for” be interpreted under 35 U.S.C. 112. Claims that do not expressly include the phrase “means for” or “step for” are not to be interpreted under 35 U.S.C. 112.

The phraseology or terminology used herein is for the purpose of description and not limitation, such that the terminology or phraseology of the present specification is to be interpreted by the skilled artisan.

The breadth and scope of the present invention should not be limited by any of the above-described exemplary embodiments, but should be defined only in accordance with the following claims and their equivalents.

What is claimed is:

1. A sowing implement, comprising:
a stake comprising a lower end and an upper end;
a depth marker arranged on the stake at a first predetermined distance from the lower end;
instructions arranged on the stake; and
a seed support connected to the stake and configured to hold one or more seeds at a second predetermined distance below the depth marker.

2. The sowing implement of claim 1, wherein the instructions are on a label.

3. The sowing implement of claim 1, wherein the instructions comprise at least one of the following:
instructions regarding how to use the sowing implement;
instructions regarding which direction a front surface of the stake should face when inserted into the ground;
instructions regarding how to water the seeds;
instructions regarding where to locate the sowing implement;
a logo;
a specification; and
an animation.

4. The sowing implement of claim 1, wherein the instructions comprise information regarding the depth to which the stake is to be inserted into the ground.

5. The sowing implement of claim 6, wherein the instructions comprise a specification comprising information regarding at least one of the following:
the type of the one or more seeds;
attributes of the one or more seeds;
attributes of a plant that the one or more seeds will mature into;
the name of a plant that the one or more seeds will mature into;
optimal growing conditions for the one or more seeds; and
a growing time for the one or more seeds.

6. The sowing implement of claim 1, wherein the one or more seeds are plant seeds.

7. The sowing implement of claim 1, wherein the seed support comprises at least one of the following:
a. a porous material;
b. a porous polymer;
c. a material comprising paper; and
d. a biodegradable material.

8. The sowing implement of claim 1, wherein the seed support comprises a perforated portion.

9. The sowing implement of claim 1, wherein the seed support comprises a dissolvable material.

10. The sowing implement of claim 1, further comprising a figurine connected to the stake.

11. The sowing implement of claim 17, wherein the figurine is movable.

12. The sowing implement of claim 1, wherein the second predetermined distance is at least ⅛ of an inch.

13. The sowing implement of claim 1, wherein the second predetermined distance is determined based on a type of seed held by the seed support.

14. The sowing implement of claim 1, wherein the stake comprises at least one of the following:
a. wooden material;
b. a polymeric material;
c. a metallic material; and
d. a biodegradable material.

15. The sowing implement of claim 1, wherein the lower end of the stake comprises a pointed region configured to facilitate insertion of the stake into the ground.

16. The sowing implement of claim 1, wherein the lower end of the stake comprises a rounded region configured to facilitate insertion of the stake into the ground.

17. The sowing implement of claim 1, wherein the instructions are located above the depth marker.

18. The sowing implement of claim 1, wherein the instructions are printed on the stake.

19. The sowing implement of claim 2, wherein the label is adhesively fixed to the stake.

20. The sowing implement of claim 1, wherein the depth marker comprises at least one of the following:
a colored indicator;
a projection protruding from the stake,
a depression in the stake;
a line; and
an arrow.
